(19) United States
(12) Patent Application Publication
(10) Pub. No.: US 2017/0316190 A1
(43) Pub. Date: Nov. 2, 2017

(54) SYSTEM AND METHOD FOR SUPPORTING OPERATIONS IN A RETAIL STORE

(71) Applicant: ASDA STORES LIMITED, Leeds (GB)

(72) Inventor: Philip Alexander STOUT, Leeds (GB)

(21) Appl. No.: 15/519,967

(22) PCT Filed: Oct. 30, 2015
(86) PCT No.: PCT/GB2015/053273

§ 371 Date: Apr. 18, 2017

(30) Foreign Application Priority Data
Oct. 31, 2014 (GB) 1419473.2

(51) Int. Cl. G06F 21/30; G06Q 30/00; G06Q 10/08

(52) U.S. Cl. CPC G06F 21/305; G06Q 10/087; G06Q 30/018

(57) ABSTRACT

A locator beacon (16) is configured to detect a nearby customer device (60), such as when a customer enters the store, and obtains identity information from the customer device (60). A server device (20) coupled to the locator beacon (16) receives the identity information and retrieves corresponding order information from an order database (28). At least one in-store device, such as a pair of wearable smart glasses (30a), is coupled to the server device (20) and is configured to receive the order information from the server (20) and display the order information to facilitate collection by the customer of one or more product items relating to the order.

### RELATED CASES

The present application claims priority under the Paris Convention to application number 1419473.2 entitled “System and Method for Supporting Operations in a Retail Store” filed on 31 Oct. 2014 in United Kingdom.

### BACKGROUND

### Technical Field

The present application relates in general to devices and methods for supporting operations in environments such as in a retail store. Particularly, the described examples relate to an apparatus and a method to assist with order collection in a retail store.

### Description of Related Art

Traditionally, a customer gathers a basket or trolley of goods in a retail store and then pays for those goods at a point of sale or checkout. Increasingly, modern retailers also provide facilities which allow a customer to order goods remotely, such as over the Internet. In some instances, the remotely ordered items are delivered directly to the customer's home. However, in other instances customers may instead wish to collect the remotely ordered items from a suitable collection point, which conveniently is located within or near to the retail store.

Modern retail stores offer a diverse selection of goods, including, foodstuffs, electronics goods, clothing, and home and kitchen goods. Customers may prefer to remotely order some types of goods (e.g. electronics goods or clothing), but prefer to purchase others (e.g. fresh foodstuffs) in person at the retail store. Furthermore, some customers may prefer to collect remotely ordered goods because the long opening hours and convenient locations of modern retail stores may make collection of goods preferable to relying on delivery services.

In the case of electronics goods, clothing, home and kitchen goods and the like, the remotely ordered items typically are held within an operational area of the store, such as a warehouse. In other cases, such as for clothing or foodstuffs, the goods may need to be gathered from display units, which may be within a sales area of the store. In either case, the retrieval of the ordered goods may take a non-trivial amount of time, and a customer arriving at a retail store to collect their order may be inconvenienced as a consequence.

In one example system, customers may be given a specific collection time, or time window, and the order is prepared in advance of the expected collection time. However, such a system lacks flexibility and may be inconvenient to the customer. Additionally, a disadvantage occurs in relation to the collection of perishable foodstuffs, which may spoil if they are gathered too early and not stored in refrigerated environment. Furthermore, there is a disadvantage in that a customer may not take the opportunity to browse the retail store because they must promptly arrive to collect their remotely ordered goods.

It is an aim of some examples to address at least some of the above difficulties, or other difficulties which will be appreciated from the description herein. It is a further aim to provide a more efficient and cost effective apparatus and method which improves operational support in a retail store or similar environment.

### SUMMARY

According to the present invention there is provided an apparatus and method as set forth in the appended claims. Other features of the invention will be apparent from the dependent claims, and the description which follows.

In one described example system, a locator beacon is configured to detect a nearby customer device, such as when a customer enters a retail store, and obtains identity information from the customer device. A server device coupled to the locator beacon receives the identity information and retrieves corresponding order information such as from an order database. At least one in-store device, such as a pair of wearable smart glasses, is coupled to the server device and is configured to receive the order information from the server and display the order information to facilitate collection by the customer of one or more product items relating to the order.

In one example there is described an order collection support system for use in a retail store, comprising: a locator beacon configured to detect a customer device which is proximate to the locator beacon and to receive identity information from the customer device; a server device coupled to the locator beacon by a communication network and configured to receive the identity information from the locator beacon and to retrieve, based on the identity information, order information stored previously in the server in response to an order by a customer; and at least one in-store device coupled to the server device by a communication network and configured to receive the order information from the server and display the order information to facilitate collection by the customer of one or more product items relating to the order.

In one example, the locator beacon is configured to interrogate a plurality of customer devices as the plurality of customer devices pass within an operating range of the locator beacon and to selectively receive the identity information from one or more of the customer devices. In one example, the locator beacon is configured to be positioned in an entrance area of the retail store to detect customer devices which enter the retail store.

In one example, the locator beacon is configured to detect the customer device by communicating with the customer device over a local wireless communication protocol. In one example, the locator beacon is a Bluetooth low energy beacon configured to communicate with the customer device over a Bluetooth protocol.

In one example, the locator beacon is configured to send a request message to the customer device, and to receive a customer device response message comprising the identity information from the customer device in response to the request message.

In one example, the server is coupled to an order database which holds order information relating to each of a plurality of orders which have been placed previously, and wherein the server is configured to retrieve the order information of a current order from the order database according to the identity information received from the customer device. In one example, the identity information comprises an order identity number.

In one example, the locator beacon is further configured to receive a deferral information from the customer device indicating a time period in the future for collection of the order. In one example, the deferral information comprises a deferral duration which indicates the length of the time period. In one example, the server is configured to wait for the deferral duration before transmitting the order information to the at least one in-store device.

In one example, the server is coupled to a plurality of the in-store devices, and wherein the server is configured to select one or more in-store devices amongst the plurality of in-store devices and to send the order information only to the selected one or more in-store devices. In one example, the server is configured to select the one or more in-store devices based on the order information.

In one example, the at least one in-store device is a wearable device which is configured to be worn by a user whilst in use.

In one example there is described a customer electronic device, comprising: a memory arranged to store an order collection application; a processor configured to execute the order collection application; a local communication unit arranged to communicate over a local area wireless protocol with a locator beacon and configured to provide identity information to the locator beacon, wherein the identity information corresponds to an order associated with the identity information; and a display configured to display one or more notifications in response to communication with the locator beacon, according to the order collection application executed by the processor.

In one example, the customer device is configured to provide a notification to the customer device on receipt of a request message from the locator beacon, and to transmit the identity information to the locator beacon in a response message upon receiving a user input in response to the notification.

In one example, the customer device is configured to receive a user input of deferral information and to transmit the deferral information to the locator beacon.

In one example there is described a method of collecting orders in a retail store, comprising: receiving, by a locator beacon, identity information from a customer device which is proximate to the locator beacon; transmitting the identity information from the locator beacon to a server; retrieving, by the server, stored order information based on the identity information; sending the order information to an in-store device, and displaying the order information on the in-store device.

In one example the method may include receiving deferral information from the customer device indicating a desired time delay prior to collection of the order; and passing the deferral information to the server.

In one example the method may include selecting one or more target in-store devices from amongst a plurality of in-store devices which are communicably coupled to the server; and sending the order information to the selected one or more target devices.

### BRIEF DESCRIPTION OF THE DRAWINGS

For a better understanding of the invention, and to show how example embodiments may be carried into effect, reference will now be made to the accompanying drawings in which:

FIG. 1 is a schematic view of an example retail store type environment in which an order collection support system may operate;

FIG. 2 is a schematic view of an exemplary order collection system;

FIG. 3 is a schematic view of an example customer device configured for use with the order collection system;

FIG. 4 is a flowchart of an exemplary method of operating a system to support an order collection process in a retail store.

In the drawings, corresponding reference characters indicate corresponding components. The skilled person will appreciate that elements in the figures are illustrated for simplicity and clarity and have not necessarily been drawn to scale. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

### DETAILED DESCRIPTION OF EXAMPLE EMBODIMENTS

At least some of the following exemplary embodiments provide an improved system and method suitable for supporting an order collection function from an order collection point, such as in a retail store. Many other advantages and improvements will be discussed in more detail below, or will be appreciated by the skilled person from carrying out exemplary embodiments based on the teachings herein. The exemplary embodiments have been described particularly in relation to a retail store such as a supermarket or general store for grocery and household items. However, it will be appreciated that the example embodiments may be applied in many other specific environments.

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

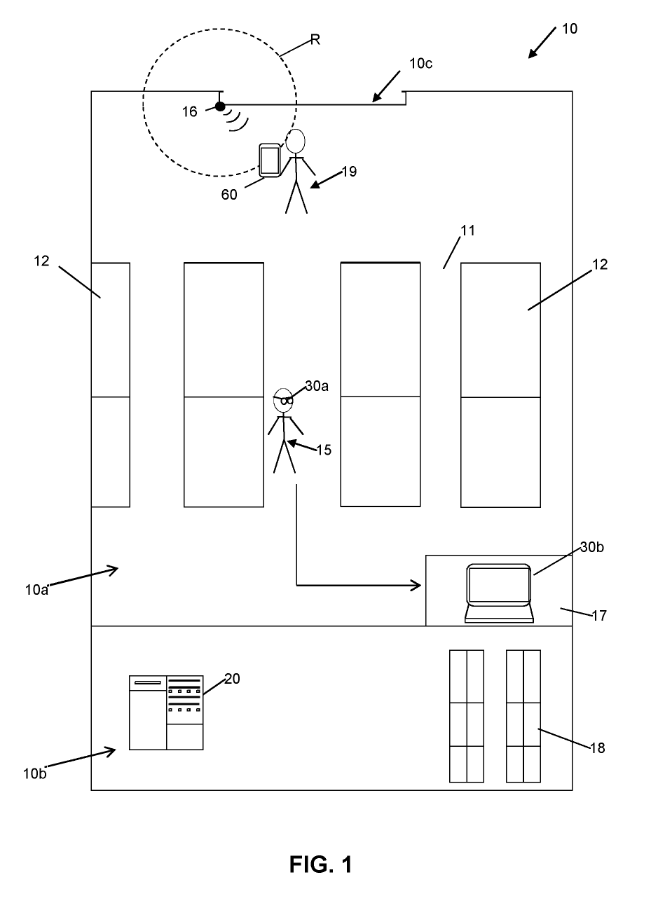

FIG. 1 shows a schematic view of a physical environment in which an exemplary embodiment of the system may operate. The physical environment may comprise a retail store 10. The retail store 10 typically comprises a sales area 10a, in which goods are displayed, and an operational area 10b, in which further stock may be held, and in which support infrastructure is installed. The sales area 10a typically includes a plurality of aisles 11, wherein each aisle further comprises a plurality of display units 12. Of course, many other specific layouts and arrangements will be apparent to the skilled person.

In this example, the sales area 10a of the retail store 10 further includes an entrance area 10c, such as a doorway through which customers enter the store 10. In one example, a locator beacon device 16 may be situated in or near to the retail store 10, in a position which allows the locator beacon to interact with customer devices 60. In one example the locator beacon 16 may be located in the entrance area 10c, in order to provide an area of coverage through which each customer will pass. The locator beacon 16 may be configured to identify one or more customer devices 60 which pass within a certain operating range R proximate to the locator beacon 16. The customer device 60 may be operated by a customer 19. The locator beacon 16 and the customer device 60 will be described in further detail below.

The operational area 10b may include one or more server computer devices 20, which will be described in further detail below. A computer network in practice may link many hundreds of stores with various local servers linked to one or more central control computers operated by the retailer, e.g. in their head office. These central control servers may in turn communicate across suitable communication networks with computer systems of suppliers, customers and manufacturers.

The operational area 10b may further comprise a product storage area 18 or similar marshalling area. In one example, the product storage area 18 may provide shelves, racking or other physical storage locations for goods corresponding to orders which have been placed in advance by customers of the retail store, ready for those goods to be collected by the customer.

In one example, the retail store 10 further comprises one or more in-store devices 30a, 30b, which may be configured to be operated by members of store staff 15. In one example, the in-store devices 30 may comprise one or more fixed terminals 30b situated at convenient points in the retail store 10. Particularly, the sales area 10a may comprise an order collection point 17, where customers collected their ordered goods, and the in-store device 30b may be a terminal located at the order collection point 17. In another example, the in-store devices may additionally or instead comprise one or more portable or wearable in-store devices 30a, configured to be carried or worn by a member of staff 15. The in-store devices 30a, 30b will be described in further detail below.

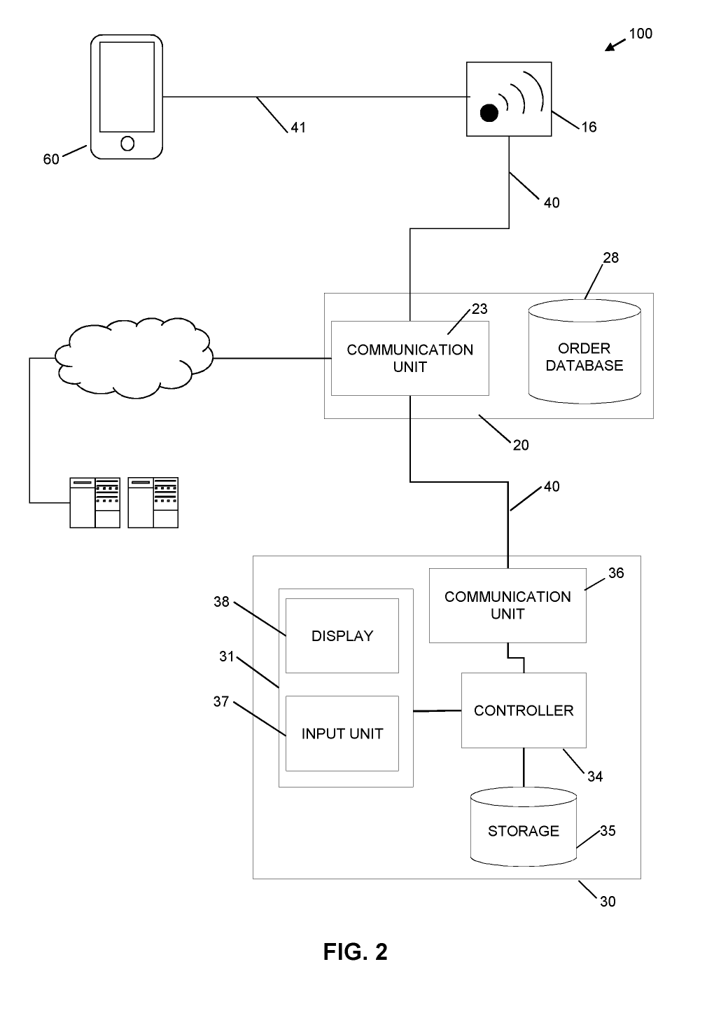

FIG. 2 is a schematic diagram showing an example order collection system 100. In one example, the system 100 includes a server 20, at least one in-store device 30 and at least one locator beacon 16.

The server 20, the locator beacon 16 and the in-store device 30 may be linked by a communication network 40. The network 40 may take any suitable form, including one or more wired and/or wireless communication links, as will be familiar to those skilled in the art. In one example, the server 20 may be located within the retail store 10, and may be connected to the in-store device 30 and the locator beacon 16 using a wired or wireless local area network (e.g. a WiFi network). In another example, the server 20 may be located off-site, e.g. in a central or regional data processing site operated by the retailer or some other remote location, and the network connection 40 between server 20 and the in-store devices 30 may include a wide area network, such as over a private leased line or the Internet.

In this example, the server 20 may further include a communication unit 23, which is operable to manage communications over the network 40 by the server 20. The server communication unit 23 may also manage communication between the server 20 and one or more other servers of the network. Thus, the server 20 may be part of a corporate server network or back-end network. For example, these other servers may be located in other stores, in other regional data processing sites or in a head office site.

In one example, the server 20 may hold an order database 28. Conveniently, the order database 28 stores order information detailing orders placed by customers 15 for collection at the retail store 10. In particular, the order database 28 may relate a user identity information (such as a user id code or similar credentials) to one or more orders which have been placed by the user. Each order may be identified, for example, by a unique order number. Each order in turn may define a list of one or more goods or product items which are identified by suitable codes (e.g. stock keeping unit codes or SKU codes). In one example, the order information held in the order database 28 may be received from a controlling server at the head office site, via the server communication unit 23.

Conveniently, the order database 28 is held on the server 20 to be accessible in use by the in-store device 30. However, it will be understood by those skilled in the art that the order database 28 could instead be stored locally on the in-store devices 30, e.g. by caching part or all of the stored information. Further, some or all of the database 28 may be made available via any other suitable computing device, e.g. as a distributed database.

In one example, the in-store device 30 may comprise a controller 34, a storage 35, a user interface (UI) module 31 and a communication unit 36. The user interface module 31 may include an input unit 37 and a display 38.

The controller 34 is operable to control the in-store device 30, and may take the form of a processor (e.g. a CPU). The storage 35 may be a non-volatile storage operable to store relevant data required for operation and control of the in-store device 30. The communication unit 36 may be operable to manage communications with the server 20 over the network 40.

The user interface module 31 is operable to input and output information to a user via one or more interfaces. In one exemplary embodiment the UI module 31 comprises an input unit 37 which is operable to receive instructions or commands from the user, and a display 38, which is operable to display at least one image to the user.

The display 38 may be a screen which is integral to the in-store device 30, but it is not limited thereto. The input unit 37 may receive user input by means of a button, a touch-screen unit, voice activation, gesture recognition or any other suitable means for receiving user instructions. The input unit 37 may also be operable to receive user input from a combination of these or other sources.

In one example, the in-store device 30 is a portable device 30a. The portable device 30a is designed and intended to be carried by a user, and is configured to be operated while in the hands of the user. In a further example, the in-store device 30 is a wearable device 30a. The wearable device 30a is also portable, but is further designed to be worn by a user during operation of the device. Advantageously, a wearable device may be configured to leave the user's hands free to perform other tasks while operating the device. The wearable device 30a may be smart glasses such as Google Glass™. In other examples, the wearable device 30a may be configured as a pendant, a smart watch, or a hat. In yet further examples, the wearable device 30a may be constructed as a patch or as a thin film incorporated in or attached to clothing, or any other piece of clothing or accessory which is adapted to incorporate technological elements. In an embodiment where the in-store device 30a is a pair of smart glasses, the display 38 may be a Heads-Up Display (HUD) on the glass or a similar display projected into the field of view of the user.

In one example, one or more of the in-store devices 30 may be configured as a terminal 30b, such as personal computer, which may be fixedly positioned within the store 10. In one example, one or more such terminals 30b may be positioned at the order collection point 17.

In one example, the locator beacon 16 is a Bluetooth low energy beacon, such as an iBeacon™. Conveniently, the locator beacon 16 may be configured to detect proximate compatible devices (e.g. Bluetooth enabled smart devices), and establish a local network connection 41 with a compatible device over Bluetooth. In one example, the proximate compatible device may be a customer device 60 operated by a customer 19, which will be described in further detail below. In one example, the locator beacon 16 is configured to detect and communicate with devices within a range R. In practical example, the range R may be of the order of approximately 1 to 5 metres. It will be understood however, that a variety of ranges may be possible, depending upon the operational characteristics of the locator beacon 16.

The locator beacon 16 is also operable to communicate with the server 20 over the network 40. The locator beacon 16 may therefore act as an intermediary on behalf of the server 20, facilitating communication of relevant data between the customer device 60 and the server 20 without requiring a direct network connection therebetween. In further examples, the locator beacons 16 may also store relevant information, which is transmitted locally over the Bluetooth or other wireless connection to the customer device 60. For example, a locator beacon unit may be loaded with information related to offers and events within the retail store 10 to be transmitted to the customer device 60. The locator beacon unit may transmit the stored information when the customer device 60 is in the proximity of that locator beacon unit 16.

Conveniently, the locator beacon 16 is positioned in an entrance area 10c of the retail store 10, thereby allowing the locator beacon 16 to detect customer devices 60 associated with customers 19 who are entering the store 10. It will be understood by those skilled in the art that the system may employ a plurality of strategically positioned locator beacons 16 to facilitate accurate detection.

In one example, the customer device 60 is a smart phone, tablet or wearable device that is owned and routinely carried by a customer 19. The customer device 60 may further comprise software configured to manage communications with the locator beacon 16. In one example the software comprises an order collection application installed on the customer device 60.

In use, the customer 19 first places an order for goods, and indicates that the goods are to be collected from the retail store 10. The order may be placed in any suitable fashion. In one example, the customer 19 places the order over the Internet. For example, the customer 19 may use a website on the World Wide Web to place the order, such as by using their customer device 60. In another example, the customer 19 may use a specifically designed software application to place the order over the Internet. In a further example, the customer 19 may use an electronic order point located in the retail store 10 to place the order for collection at a later time. In still further examples, the customer 19 may place an order over the telephone for later collection.

In one example, the order information relating to the order is received by a remote computer system, such as a head office server or a server in a central or regional data processing site operated by the retailer, or some other remote source. The order information is added to the order database 28 accessible to the relevant store server 20 of the retail store 10 where the customer 19 intends to collect their goods. For example, the order information is received by the communication unit 23, and stored in the order database 28.

The order information includes details of the goods which have been ordered. The order information may also include any other relevant order metadata, such as an order id number and/or a customer id number. In one example, the order information may include an approximate collection time and/or details of the customer 19 for use in the verification of the customer's identity upon collection.

Some time subsequently, the customer 19 may arrive at a collection site, which in this example is in the retail store 10, to collect the goods which have been ordered. In this example, the customer 19 may carry the customer device 60 about their person on arrival to the store 10.

Next, the customer 19 passes through the entrance area 10c of the retail store 10 on arrival. Consequently, the customer device 60 enters the range R of the at least one of the locator beacons 16. In response to the customer device 60 entering the range R, the locator beacon 16 establishes a local connection 41 with the customer device 60.

Next, the locator beacon 16 obtains the identity of the customer device 60. In one example, the locator beacon sends a request message to the customer device 60. In response, the order collection application running on the customer device 60 transmits an identity information response message to the locator beacon 16.

In one example, the customer device 60 may provide a notification to the customer 19 that prompts the customer 60 to transmit the identity information response message. For example the request message may result in the display of a message such as “Welcome to the store. Are you here to collect an order?”. The customer 19 then controls the customer device 60, for example by pressing a relevant button or making a relevant touch screen input, to send the identity information response message.

In a further example, the order collection application runs in the background on the customer device 60 and may automatically transmit the identity information response message without requiring user input.

The identity information response message comprises identity information relating to the order to be collected. In one example, the identity information may comprise an order ID number or other similar identifier.

In one example, the identity information is pre-stored on the customer device 60. For example, the customer 19 may have originally placed the order on the customer device 60, and received and stored the identity information automatically in response.

In a further example, the identity information may be manually entered by the customer 19 into the customer device 60. For example, if the order has been placed in the retail store 10, e.g. at an electronic order point, the customer 19 may receive a printout which details the identity information. The customer 19 then inputs the identity information into the customer device 60 manually. Alternatively, the printout may comprise a machine-readable printed code (e.g. a barcode) which can be scanned and interpreted by an image capture element such as a camera of the customer device 60.

In one example, the identity information response message may additionally include deferral information. The deferral information may indicate that the customer desires to delay the collection of their order, for example whilst they browse the retail store 10. The deferral information may comprise a deferral duration which indicates the length of deferral preferred by the customer. In one example, the deferral information may be generated based on user input received via the order collection application. Particularly, the order collection application may include an option to indicate deferral information in reply to the request message.

In one example, the locator beacon 16 transmits the received identity information response message to the server 20. In use, the server 20 retrieves order information stored in the order database 28 corresponding to the identity information in the received identity information response message. The server 20 then transmits the order information to at least one in-store device 30.

In one example where the identity information response message comprises deferral information, the server 20 may wait for a determined period of time before transmitting the order information. Particularly, if the deferral information includes the deferral duration, the server 20 waits for the deferral duration before transmitting the order information.

In one example, the server 20 may transmit the order information message to the in-store device including an indication of a deferral period that has been received from the customer device 60. Thus, interaction between the customer and the store is improved, by allowing the user to confirm that they are present on this occasion to collect an order, and further by allowing the user to specify a desired collection time which conveniently may be in the near future. The deferral information then allows the store staff to coordinate more effectively with the customer, supported by interactions and messages which are routed through the system.

In one example where several in-store devices 30 are connected to the server 20, the server 20 may determine one or more appropriate in-store devices 30 to receive the order information message. The server 20 may select one or more recipient devices amongst a current population of the in-store devices 30. In one example, the determination is made based on the order information. For example, an order comprising goods stored in the storage area 18, e.g. electronic goods or clothing, may be transmitted to an in-store device 30b at an order collection point 17, proximate to the respective storage area 18. An order comprising goods which are located on display units 12 in the store, such as an order comprising foodstuffs or perishable goods may be instead or additionally transmitted to a portable or wearable in-store device 30a being operated by a member of staff 15 located in the sales area 10a, and proximate to the ordered goods. Thus, the system may improve operational efficiency by appropriately directing the order information messages to the appropriate in-store devices according to criteria which may be applied appropriately for each respective customer order and collection instance.

An order collection team may be designated by the system and may receive each new order information. The in-store devices operated by the order collection team may further update and display a list of current orders that are due to be collected (optionally alongside relevant time information such as a remaining time until collection). The system may further support co-operative messaging amongst the in-store devices such as by allowing one team member to signal that they are managing a certain order or have picked certain items for part of a certain order.

In use, one or more members of staff 15 who receive the transmitted message on the relevant in-store devices 30a, 30b may then gather the ordered items and, for example, convey the items to the order collection point 17. Finally, the customer 19 then collects the goods from the order collection point 17.

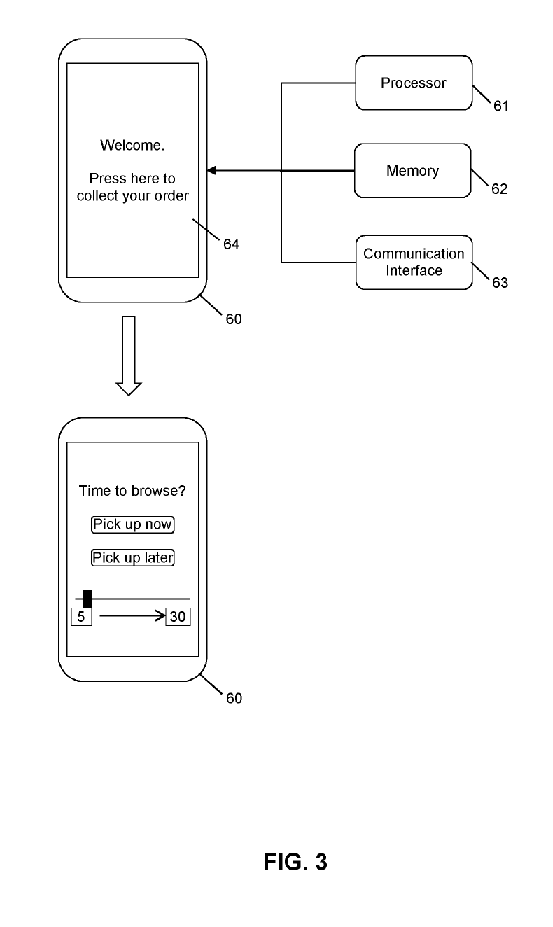

FIG. 3 shows an example of the customer device 60 in more detail. The customer device may include a processor 61 and a memory 62 of a type that will be familiar to those skilled in the art. The customer device 60 may include a local communication unit 63 which is capable of communicating with the locator beacon 16, such as a Bluetooth communication unit. The customer device 60 may also have a display unit 64, such as a display screen. In operation, the customer device 60 may exchange messages with the locator beacon 16 and/or may communicate with the server 20 (e.g. via a local WiFi network or other wireless communication network). In some examples, communications with the customer device 60 may occur partially over a Bluetooth connection with the locator beacon and may continue partially by using an in-store WiFi network (e.g. to continue communication when the user moves further into the store).

In one example, the display screen 64 is controlled by an order collection application operating on the device. The customer device 60 may display a notification for the user to confirm that the order collection function is operating correctly (i.e. that the user has been recognised by the locator beacon 16). The customer device 60 may be operated to confirm that the user wishes to proceed with the order collection on this visit to the store. The customer device 60 may further allow the user to input a deferral request, in this example in the form of a slider allowing deferral of between 5 and 30 minutes from the present time. Further messages may be exchanged with the customer device 60, such as to remind to customer of their indicated collection time or to inform the customer of progress concerning their order.

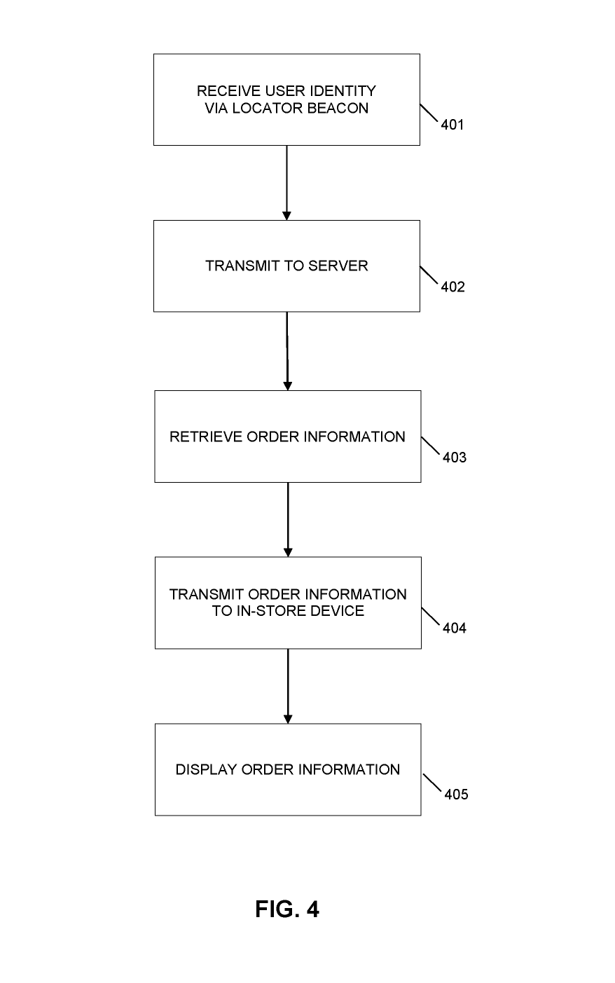

FIG. 4 is a schematic flowchart of an example method. The method may include the step 401 of receiving identity information at the locator beacon 16 from a customer device 60 which is proximate to the locator beacon 16. The method may include the step 402 of transmitting the identity information from the locator beacon 16 to the controlling server 20. The method may include the step 403 of retrieving by the server 20 stored order information based on the received identity information. The method may include the step 404 of transmitting the retrieved order information to the in-store device 30, such as the wearable device 30a and/or the fixed terminal 30b. The method may include the step 405 of displaying the order information on the in-store device. A store employee may then process the order knowing that the customer has arrived in the store. Further steps may be included in the method, as have been described herein.

The above-described systems and methods may advantageously allow a retail store to effectively manage the collection of ordered goods. Particularly, the systems and methods provide a convenient system for alerting members of staff to the arrival of a customer wishing to collect an order. Consequently, the order can be prepared or made ready for collection in the time between the customer entering the store or its vicinity, and reaching the order collection point, thereby reducing customer waiting time.

The above described systems and methods take advantage of the increased availability of smart devices such as smart phones, tablets and wearable devices, by interacting with the devices to efficiently facilitate order collection. The above-described examples provide a simple and intuitive system which may be easily operated with minimal training by customers and store staff alike.

Although a few preferred embodiments have been shown and described, it will be appreciated by those skilled in the art that various changes and modifications might be made without departing from the scope of the invention, as defined in the appended claims.

Although the example embodiments have been described with reference to the components, modules and units discussed herein, such functional elements may be combined into fewer elements or separated into additional elements. Various combinations of optional features have been described herein, and it will be appreciated that described features may be combined in any suitable combination.

In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

1. An order collection support system for use in a retail store, comprising:
a locator beacon configured to detect a customer device which is proximate to the locator beacon and to receive identity information from the customer device;
a server device coupled to the locator beacon by a communication network and configured to receive the identity information from the locator beacon and to retrieve, based on the identity information, order information stored previously in the server device in response to an order by a customer; and
at least one in-store device coupled to the server device by a communication network and configured to receive the order information from the server device and display the order information to facilitate collection by the customer of one or more product items relating to the order.

2. The system of claim 1, wherein the locator beacon is configured to interrogate a plurality of customer devices as the plurality of customer devices pass within an operating range of the locator beacon and to selectively receive the identity information from one or more of the customer devices.

3. The system of claim 1, wherein the locator beacon is configured to be positioned in an entrance area of the retail store to detect customer devices which enter the retail store.

4. The system of claim 1, wherein the locator beacon is configured to detect the customer device by communicating with the customer device over a local wireless communication protocol.

5. The system of claim 1, wherein the locator beacon is a Bluetooth low energy beacon configured to communicate with the customer device over a Bluetooth protocol.

6. The system of claim 1, wherein the locator beacon is configured to send a request message to the customer device, and to receive a customer device response message comprising the identity information from the customer device in response to the request message.

7. The system of claim 1, wherein the server device is coupled to an order database which holds order information relating to each of a plurality of orders which have been placed previously, and wherein the server device is configured to retrieve the order information of a current order from the order database according to the identity information received from the customer device.

8. The system of claim 1, wherein the identity information comprises an order identity number.

9. The system of claim 1, wherein the locator beacon is further configured to receive a deferral indication from the customer device indicating a time period in the future for collection of the order.

10. The system of claim 9, wherein the deferral indication comprises a deferral duration which indicates the length of the time period.

11. The system of claim 10, wherein the server device is configured to wait for the deferral duration before transmitting the order information to the at least one in-store device.

12. The system of claim 1, wherein the server device is coupled to a plurality of the in- store devices, and wherein the server device is configured to select one or more in-store devices amongst the plurality of in-store devices and to send the order information only to the selected one or more in-store devices.

13. The system of claim 12, wherein the server device is configured to select the one or more in-store devices based on the order information.

14. The system of claim 1, the at least one in-store device is a wearable device which is configured to be worn by a user whilst in use.

15. A customer electronic device, comprising:
a memory arranged to store an order collection application;
a processor configured to execute the order collection application;
a local communication unit arranged to communicate over a local area wireless protocol with a locator beacon and configured to provide identity information to the locator beacon, wherein the identity information corresponds to an order associated with the identity information; and
a display configured to display one or more notifications in response to communication with the locator beacon, according to the order collection application executed by the processor.

16. The customer device of claim 15, wherein the customer device is configured to provide a notification to the customer device on receipt of a request message from the locator beacon, and to transmit the identity information to the locator beacon in a response message upon receiving a user input in response to the notification.

17. The customer device of claim 15, wherein the customer device is configured to receive a user input of deferral information and to transmit the deferral information to the locator beacon.

18. A method for supporting operations in a retail store, comprising:
receiving, by a locator beacon, identity information from a customer device which is proximate to the locator beacon;
transmitting the identity information from the locator beacon to a server device;
retrieving, by the server device, stored order information based on the identity information;
sending the order information to an in-store device; and
displaying the order information on the in-store device.

19. The method of claim 18, further comprising:
receiving deferral information from the customer device indicating a desired time delay prior to collection of the order; and
passing the deferral information to the server device.

20. The method of claim 18, further comprising:
selecting one or more target in-store devices from amongst a plurality of in-store devices which are communicably coupled to the server device; and
sending the order information to the selected one or more target devices.
